(19) United States
(12) Patent Application Publication
(10) Pub. No.: US 2008/0271904 A1
(43) Pub. Date: Nov. 6, 2008

(54) Power hand tool

(75) Inventor: Yung-Tsung Lin, Taichung City (TW)

Correspondence Address: BACON & THOMAS, PLLC, 625 SLATERS LANE, FOURTH FLOOR, ALEXANDRIA, VA, 22314-1176, US

(73) Assignee: MOBILETRON ELECTRONICS CO., LTD., TAICHUNG HSIEN (TW)

(21) Appl. No.: 11/797,400

(22) Filed: May 3, 2007

(51) Int. Cl. B25B 23/00

(52) U.S. Cl. 173/20

(57) ABSTRACT

A power hand tool includes a housing, a motor, a speed change gear set, gearshift position control device, and a display member. The housing includes a longitudinal sliding slot. The motor mounted inside the housing. The speed change gear set is mounted inside the housing. The gearshift position control device is movably mounted in the longitudinal sliding slot to shift the speed change gear set to one of a series of gearshift positions for multi-speed output of the motor, having an indication zone and a display member. The indication zone has multiple numerical signs corresponding to the gearshift positions. The display member is fixedly mounted in the longitudinal sliding slot, having a light-penetrable display zone capable of magnification and corresponding to the indication zone for magnifying one of the numerical signs, and a lamp mounted inside the housing for illuminating the indication zone.

### BACKGROUND OF THE INVENTION

1. Field of the Invention

The present invention relates to power hand tools, and more particularly to such a power hand tool, which current gearshift position can be simply viewed.

2. Description of the Related Art

A conventional power hand tool, particularly, a power screwdriver has a speed change gear set coupled to a motor for controlling multiple output speed of the motor, i.e. for controllably increasing or reducing the speed of the motor.

A gearshift lever mounted outside the housing of the power hand tool controls the gearshift position of the speed change gear set. By means of changing the position of the gearshift lever, the gearshift position of the speed change gear set is relatively changed. However, a user who firstly uses the power hand tool or is not familiar with the functioning of the speed change gear set or operates the power hand tool in the dim environment may not identify the actual gearshift position of the speed change gear set, and thus the power hand tool may be improperly operated to result in damage.

### SUMMARY OF THE INVENTION

The present invention has been accomplished under the circumstances in view. It is therefore one object of the present invention to provide a power hand tool, which indicates a numerical sign in a magnified scale indicative of the current gearshift position of the speed change gear set thereof to facilitate the operation.

To achieve the object of the present invention, the power hand tool is composed of a housing having a longitudinal sliding slot in communication with the outside; a motor mounted inside the housing for providing a rotary driving force; a speed change gear set mounted inside the housing and coupled to the motor for changing the rotary driving force of the motor to multi-speed output; a gearshift position control device slidably mounted in the longitudinal sliding slot and having a finger block and an indication zone for adjusting the output speed of the speed change gear in such a way that the user shifts the finger block to control the gearshift position control device for multi-stage sliding movement along the longitudinal sliding slot, wherein the indication zone is provided with multiple numerical signs corresponding to the gearshift positions; and a display device having a display member and a lamp. The display member is mounted in the longitudinal sliding slot, having a light-penetrable display zone capable of magnification and corresponding to the indication zone for magnifying one of the numerical signs of the indication zone. The lamp is mounted to the housing and toward the indication zone for illuminating the indication zone.

### BRIEF DESCRIPTION OF THE DRAWINGS

FIG. 1 is an exploded view of a power hand tool according to the present invention.

FIG. 2 is a top view of the power hand tool according to the present invention, showing the speed change gear set in the second gearshift position.

FIG. 3 is a sectional view of the power hand tool according to the present invention, showing the speed change gear set in the second gearshift position.

FIG. 4 is a top view of the power hand tool according to the present invention, showing the speed change gear set in the third gearshift position.

FIG. 5 is a sectional view of the power hand tool according to the present invention, showing the speed change gear set in the third gearshift position.

FIG. 6 is a top view of the power hand tool according to the present invention, showing the speed change gear set in the first gearshift position.

FIG. 7 is a sectional view of the power hand tool according to the present invention, showing the speed change gear set in the first gearshift position.

### DETAILED DESCRIPTION OF THE INVENTION

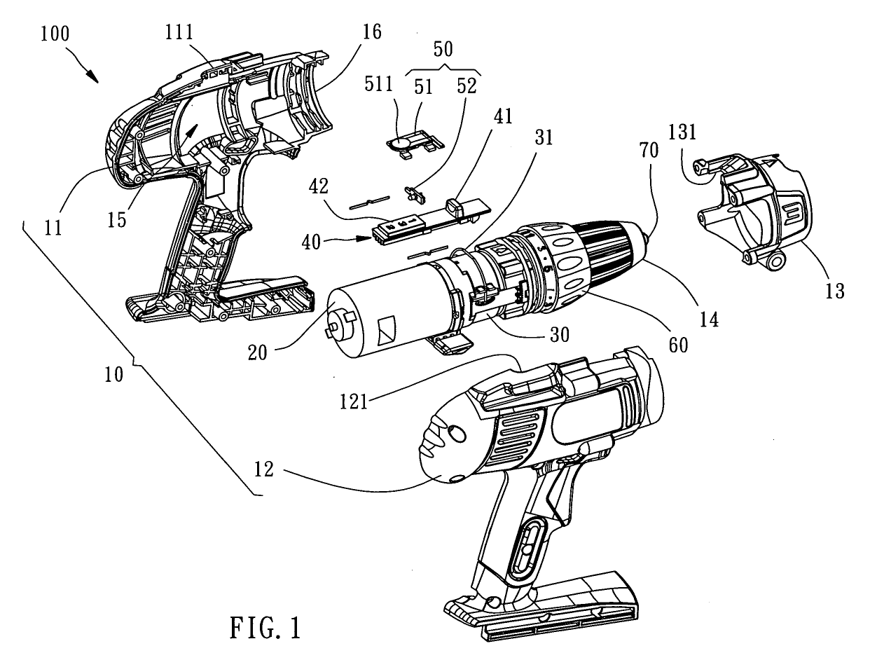

Referring to FIGS. 1-7, a power hand tool 100 in accordance with the present invention is shown comprised of a housing 10, a motor 20, a battery pack (not shown), a speed change gear set 30, a gearshift position control device 40, a display device 50, and a torque adjustment device 60.

The housing 10 includes a first half shell 11, a second half shell 12, a front shell 13, and a front cap 14. The first half shell 11 and the second half shell 12 are closely abutted together to define an accommodation chamber 15 located therebetween and an opening 16 located at one end thereof in communication with the accommodation chamber 15. A first top notch 111 and a second top notch 121 are respectively formed at top ends of the first half shell and the second half shell 12, in communication with the accommodation chamber 15 and corresponding to each other. The front shell 13 is mounted to the first half shell 11 and the second half shell 12 and located close to the opening 16 to secure combination of the first half shell 11 and the second half shell 12. Further, a third top notch 131 is formed at a top end of the front shell 13. When the two half shells 11 and 12 and the front shell 13 are fastened together, the first, second, and third top notches 111, 121, and 131 together define a longitudinal slot 17 in communication with the accommodation chamber 15.

The motor 20 is fixedly mounted inside the accommodation chamber 15 for providing a rotary driving force.

The battery pack (not shown) is detachably mounted to the housing 10 for providing electricity for the motor 20.

The speed change gear set 30 is mounted in the accommodation chamber 15 and coupled to the motor 20 for changing the constant rotational speed of the motor 20 to multi-speed output, e.g. three speeds including low speed, high speed, and medium speed in this embodiment. The speed change gear set 30 has a gearshift lever 31 that can be shifted to one of a series of positions to change the rotary driving force of the motor 20 to a corresponding speed output (LOW/HIGH/MEDIUM).

The gearshift position control device 40 is slidably mounted in the accommodation chamber 15 inside the housing 10 for multi-stage sliding movement along the longitudinal slot 17, having a finger block 41 and an indication zone 42 on a top side thereof. The indication zone 42 has the signs of 1/3/2 or LOW/HIGH/MEDIUM. The finger block 41 and the indication zone 42 are exposed outside the longitudinal slot 17. The gearshift position control device 40 can be moved to shift the gearshift lever 31 to one of the three gearshift positions (1/3/2), thereby adjusting the speed output of the speed change gear set 30.

The display device 50 includes a display member 51 and a lamp 52. The display member 51 is integrally made by injection molding, having a light-penetrable display zone 511 which is a convex lens for visual magnification in this embodiment. The display member 51 is mounted to one end of the longitudinal slot 17 and located at outside the indication zone 42 of the gearshift position control device 40. The lamp 52 is mounted in the housing 10, is located between the display member 51 and the gearshift position control device 40, is electrically connected to the battery pack, and faces toward one of the signs of 1/3/2 (or LOW/HIGH/MEDIUM) of the indication zone 42, for illuminating the indication zone 42 of the gearshift position control device 40, so that the user can see the sign 1, 3, or 2 (LOW, HIGH, or MEDIUM) at the indication zone 42 of the gearshift position control device 40 through the light-penetrable display zone (magnifying lens) 511.

The torque adjustment device 60 has one end, namely, the rear end fitted into the front shell 13 and connected with the speed change gear set 30 for allowing the user to adjust the maximum output torque value. The front cap 14 of the housing 14 is capped on the other end thereof, namely, the front end of the torque adjustment device 60. Further, the motor 20 has an output shaft 70 connected to the torque adjustment device 60 and the speed change gear set 30 and extending out of the front cap 14 of the housing 10.

After introduction of the parts of the power hand tool 100, the operation of the power hand tool 100 is described hereinafter.

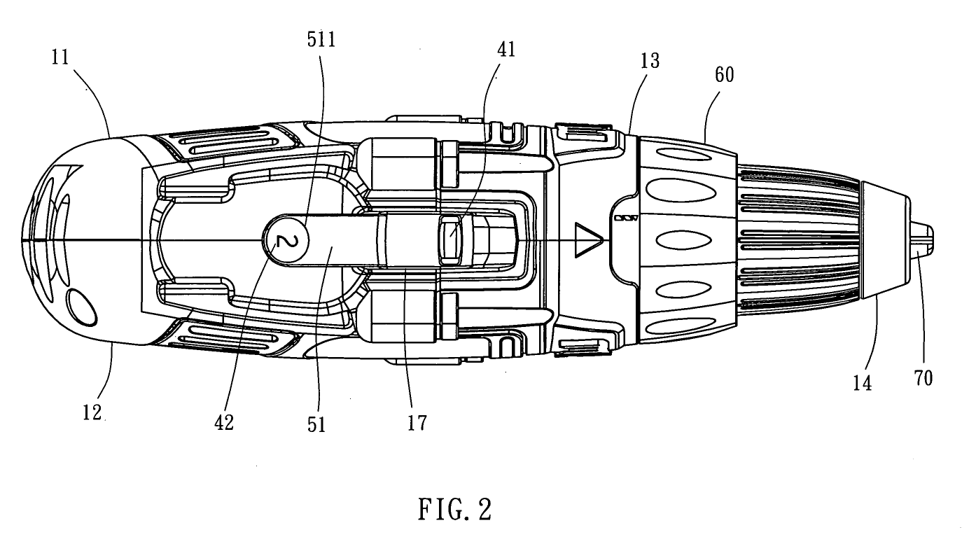

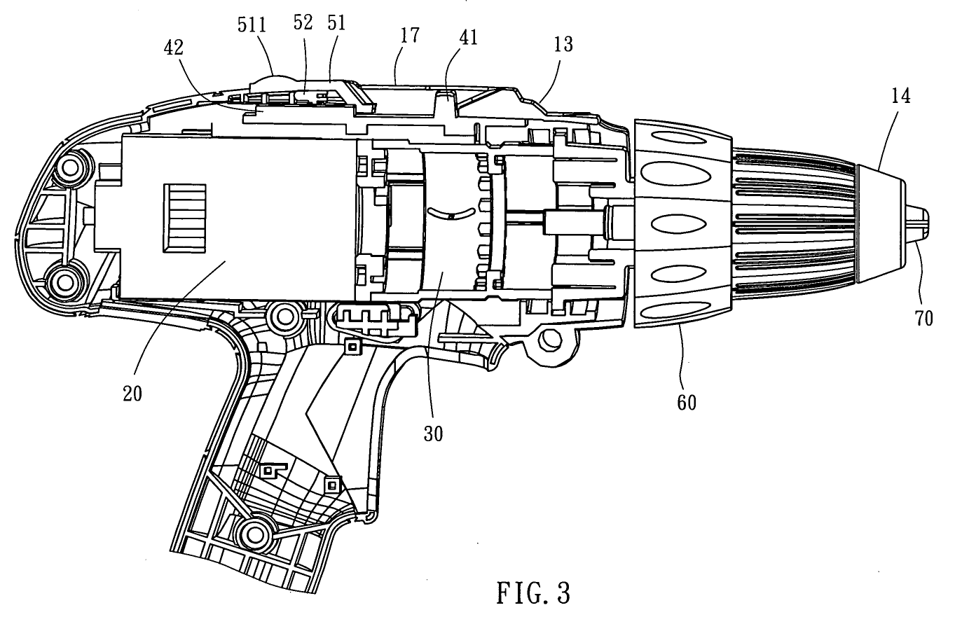

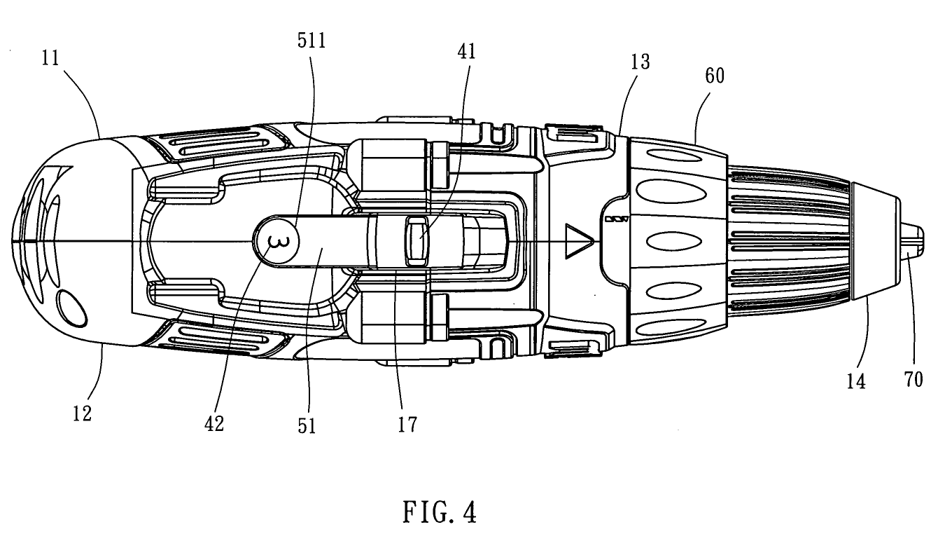

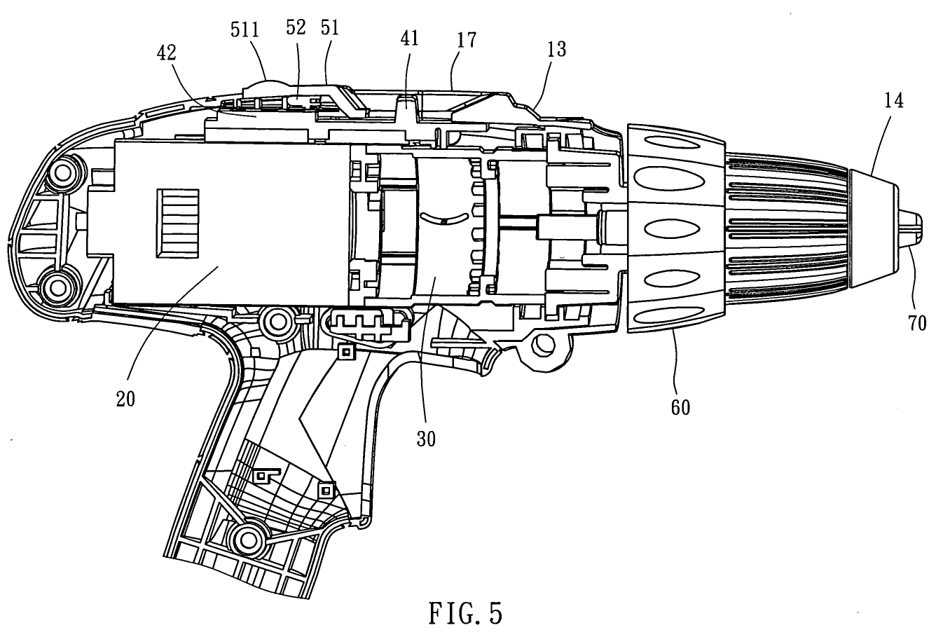

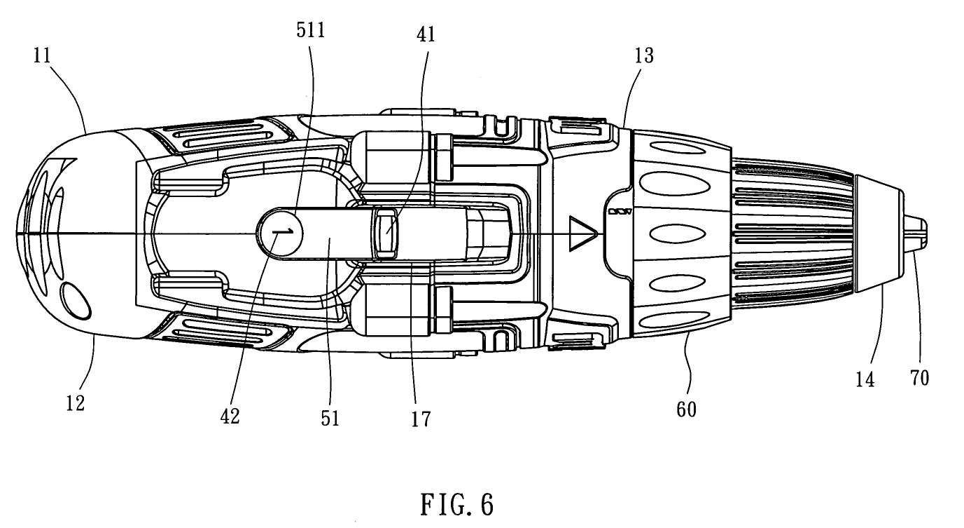

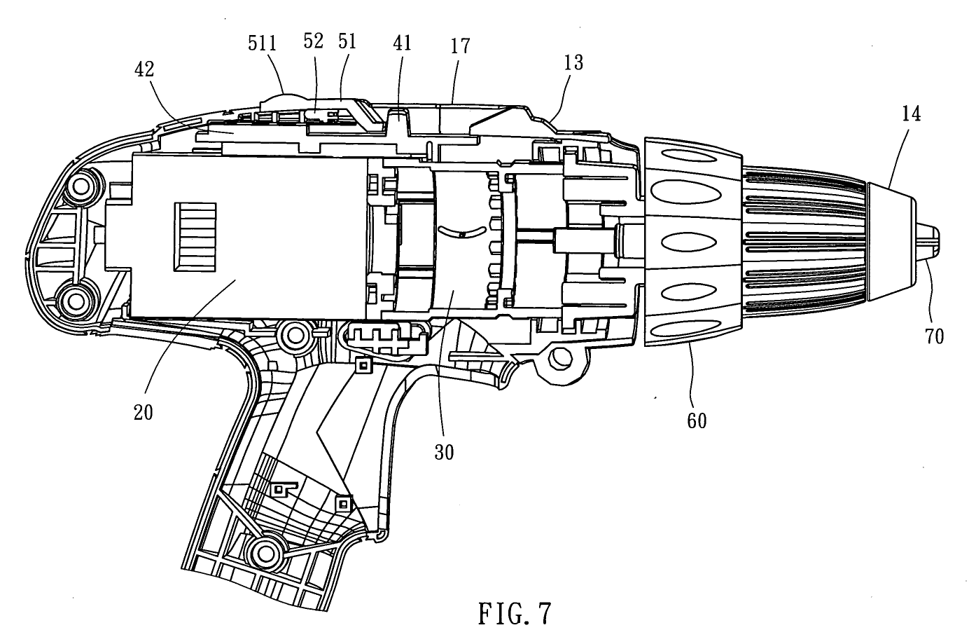

At first, the user can switch the finger block 41 to move the gearshift position control device 40 along the longitudinal slot 17 of the housing 10 to one of the three gearshift positions (1/3/2). As shown in FIGS. 2 and 3, when the gearshift position control device 40 is shifted to the second gearshift position (medium speed), the sign “2” in the indication zone 42 is aligned with the light-penetrable display zone (magnifying lens) 511 and illuminated by the lamp 52. Therefore, the user can see clearly the sign “2” in a magnified scale through the light-penetrable display zone (magnifying lens) 511. As shown in FIGS. 4 and 5, when the gearshift position control device 40 is shifted to the third gearshift position (high speed), the sign “3” in the indication zone 42 is aligned with the light-penetrable display zone (magnifying lens) 511 and illuminated by the lamp 52. Therefore, the user can see clearly the sign “3” in a magnified scale through the light-penetrable display zone (magnifying lens) 511. As shown in FIGS. 6 and 7, when the gearshift position control device 40 is shifted to the first gearshift position (low speed), the sign “1” in the indication zone 42 is aligned with the light-penetrable display zone (magnifying lens) 511 and illuminated by the lamp 52. Therefore, the user can see clearly the sign “1” in a magnified scale through the light-penetrable display zone (magnifying lens) 511.

Therefore, the user can see the sign of the current gearshift position in a magnified scale through the light-penetrable display zone under the illumination of the lamp. In other words, the user knows the actual current gearshift position of the speed change gear set during operation.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A power hand tool comprising:
a housing having a longitudinal sliding slot in communication with the outside;
a motor mounted inside said housing for providing a rotary driving force;
a speed change gear set mounted in said housing and connected with said motor for changing the rotary driving force of said motor to multi-speed output;
a gearshift position control device movably mounted in said housing for multi-stage movement along longitudinal sliding slot to shift the rotary driving force for adjusting the multi-speed output of said speed change gear set, said gearshift position control device having a finger block and an indication zone, said indication zone having multiple numerical signs thereon; and
a display device having a display member and a lamp, said display member being mounted in said longitudinal sliding slot and having a light-penetrable display zone capable of magnification and corresponding to said indication zone for magnifying one of the numerical signs of said indication zone, said lamp being mounted to said housing and facing toward the indication zone for illuminating said indication zone.

2. The power hand tool as claimed in claim 1, wherein said housing comprises a first half shell, a second half shell abutted to said first half shell and defining with said first half shell an accommodation chamber and an opening at a front side of said accommodation chamber and in communication with said accommodation chamber, a front shell fastened to said first half shell and second half shell and located close to said opening, a first top notch formed on said first half shell, a second top notch formed on said second half shell, and a third top notch formed on said front shell, said first, second, and said third top notches together defining said longitudinal sliding slot.

3. The power hand tool as claimed in claim 1, further comprising a battery pack detachably mounted to said housing for provide electricity for said motor and said lamp.

4. The power hand tool as claimed in claim 1, wherein said speed change gear set can change the rotary driving force of said motor to one of three output speeds, having a gearshift lever connected to said gearshift position control device.

5. The power hand tool as claimed in claim 1, further comprising a torque adjustment device connected to said speed change gear set for adjusting the user's desired maximum output torque.

6. The power hand tool as claimed in claim 1, wherein the wherein said display member is made in one piece.
